(19) United States
(12) Patent Application Publication
(10) Pub. No.: US 2006/0034465 A1
(43) Pub. Date: Feb. 16, 2006

(54) Apparatus for selectively outputting audio and video signal or headphone signal using analog switch and method thereof

(75) Inventor: Dae-Hyun Jeong, Ansan-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/198,331

(22) Filed: Aug. 8, 2005

(30) Foreign Application Priority Data
Aug. 13, 2004 (KR) 2004-63707

(51) Int. Cl. H04R 1/10

(52) U.S. Cl. 381/74; 381/384

(57) ABSTRACT

Disclosed are an apparatus and method for selectively outputting an audio/video signal and a headphone signal through a common jack using an analog switch and a method thereof in a portable composite appliance. It is determined whether a specified plug is inserted into a common jack. If the specified plug that is identified as a headphone plug, a first logic level is output to a switching unit, which performs a switching operation and an audio signal is output to the headphones. Alternatively, if the inserted plug is identified as an audio/video plug, a second logic level is output to a switching unit, which performs a switching operation and an audio/video signal is output to the audio and video device.

### CROSS-REFERENCE TO RELATED APPLICATION

This application claims the benefit under 35 U.S.C. §119(a) of a Korean Patent Application No. 2004-63707, filed on Aug. 13, 2004, in the Korean Intellectual Property Office, the entire content of which is hereby incorporated by reference.

### BACKGROUND OF THE INVENTION

1. Field of the Invention

The present invention relates generally to a portable composite appliance. More particularly, the present invention relates to an apparatus for selectively outputting an audio and video signal or a headphone signal through a common jack using an analog switch, and a method thereof in a portable composite appliance.

2. Description of the Related Art

A portable composite appliance is a small-sized appliance having functions of a camcorder, a digital camera, a digital music player, a voice recorder, a data storage device, a web camera, and the like. Such a portable composite appliance has been developed through the application of digital technology to a video processing apparatus such as a camcorder and so on.

Using such a portable composite appliance, a user can film and record a moving image on a recording tape as the user moves, and can reproduce and view the recorded moving image. In reproducing the moving image, the user can view the recorded image through a display device such as a view finder provided in the portable composite appliance, an LCD monitor, or other suitable display means, or through an external display device such as a television receiver (TV), a video player, or the like, connected to the portable composite appliance.

In this case, in order to connect the portable composite appliance to the external display device such as the TV, the video player, or the like, an audio/video jack is used. Additionally, in order for the user to listen to music files reproduced by a digital music player and so on provided in the portable composite appliance, a headphone jack is used.

The above-described conventional portable composite appliance has the audio/video jack and the headphone jack separated from each other, and they occupy a large amount of space, which makes it difficult to further miniaturize the device.

### SUMMARY OF THE INVENTION

The present invention has been developed in order to solve the above drawbacks and other problems associated with the conventional arrangement. An aspect of the present invention is to provide to an apparatus that can selectively output an audio/video signal or a headphone signal through a common jack using an analog switch, and thus reduce space occupied by the audio/video and headphone jacks thereby allowing the portable composite appliance to be miniaturized.

The foregoing and other objects and advantages are substantially realized by providing a method for selectively outputting an audio/video signal and a headphone signal, according to an embodiment of the present invention, which comprises the steps of performing a reproduction of a moving image or a music file after a power supply is provided, determining whether a specified plug is inserted into a common jack, if the specified plug is inserted as a result of the determination, identifying the type of plug that is inserted, and if the inserted plug is identified as a headphone plug, performing a switching operation so that an audio signal is outputted to a headphone connected to the common jack by generating and outputting a switching control signal having a first logic level.

It is preferable that the method further comprises the step of if the inserted plug is an audio/video plug as a result of the identification, performing a switching operation so that an audio/video signal is output to an external appliance through the audio/video plug connected to the common jack by creating and outputting a switching signal having a second logic level.

It is preferable that the step of identifying the type of plug that is inserted is identified by the detection of a level of a signal output from a specified terminal of the inserted plug.

It is preferable that the method further comprises the step of if the specified plug is not inserted into the common jack, outputting the audio signal to a speaker.

In another aspect of the present invention, there is provided an apparatus for selectively outputting an audio/video signal or a headphone signal, which comprises a common jack for outputting the audio/video signal to a headphone and an external display device, a microcomputer for determining whether a specified plug is inserted into the common jack, and if the specified plug is inserted as a result of the determination, identifying the type of plug that is inserted. The microcomputer creates and outputs a switching control signal of a first logic level if the specified plug is a headphone plug, and creates and outputs a switching control signal of a second logic level if the specified plug is an audio/video plug, and a switching unit for performing a switchover to a specified headphone terminal according to the switching control signal of the first logic level and performing a switchover to a specified audio/video terminal according to the switching control signal of the second logic level.

It is preferable that if the switchover to the headphone terminal is performed, the audio signal is output to the headphone connected to the common jack.

It is preferable that if the switchover to the audio/video terminal is performed, the audio/video signal is output to an external appliance through the audio/video plug connected to the common jack.

It is preferable that the microcomputer identifies the type of plug that is inserted by detecting a signal level output from a specified terminal of the inserted plug.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram illustrating the construction of an apparatus for selectively outputting an audio/video signal and a headphone signal using an analog signal according to an embodiment of the present invention;

FIG. 2 is a flowchart illustrating a method for selectively outputting an audio/video signal and a headphone signal using an analog signal according to an embodiment of the present invention; and

FIG. 3 is a view illustrating exemplary signals related to respective terminals of a headphone plug and an audio/video plug according to an embodiment of the present invention.

Throughout the drawings, it should be understood that like reference numerals refer to like features, structures, and elements.

### DETAILED DESCRIPTION OF EXEMPLARY EMBODIMENTS

Exemplary embodiments of the present invention will be described in greater detail with reference to the accompanying drawings.

The matters defined in the description such as a detailed construction and elements are provided to assist in a comprehensive understanding of the invention. Thus, it is apparent that the present invention can be carried out without those defined matters. Also, descriptions of well-known functions or constructions are omitted for the sake of clarity and conciseness.

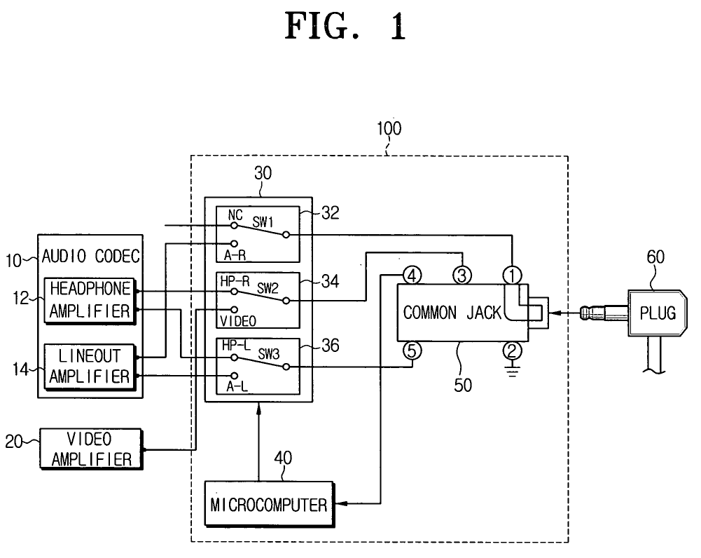

FIG. 1 is a block diagram illustrating the construction of an apparatus for selectively outputting an audio/video signal and a headphone signal using an analog signal according to an embodiment of the present invention. Referring to FIG. 1, the apparatus for selectively outputting an audio/video signal and a headphone signal using an analog switch according to an embodiment of the present invention includes a switching unit 30, a microcomputer 40, and a common jack 50.

The switching unit 30 performs a switchover from specified terminals HP-R and HP-L related to a headphone plug to specified terminals A-R, VIDEO, and A-L related to an audio/video plug and vice versa under the control of the microcomputer 40.

The microcomputer 40 determines whether a plug 60 is inserted into the common jack 50, and if the plug 60 is inserted into the common jack 50, the microcomputer 40 identifies whether the plug 60 inserted into the common jack 50 is the headphone plug or the audio/video plug. Additionally, the microcomputer 40 identifies the type of plug that is inserted, and then controls the switching unit 30 so that analog switches SW1 to SW3 are connected to the specified terminals corresponding to the recognized plug 60.

The common jack 50 is a device for outputting the audio and video signals to a headphone and an external display device, respectively. The common jack 50 is connected to the switching unit 30, the microcomputer 40, and ground GND, preferably, through a plurality of terminals \textcircled{1} to \textcircled{5} installed inside the common jack, and has a specified space for receiving the inserted plug 60.

Meanwhile, an audio codec 10 illustrated in FIG. 1 comprises a coder for converting an analog audio signal into a digital audio signal and a decoder for converting a digital audio signal into an analog audio signal.

The audio codec 10 converts an analog music or audio signal into digital signal that can be recognized by a computer, and stores the converted digital signal. During a reproduction operation, the audio codec 10 converts a digital signal into an analog music or audio signal, and outputs the analog music or audio signal through a lineout terminal (not illustrated).

The audio codec 10 comprises a headphone amplifier 12 and a lineout amplifier 14. The headphone amplifier 12 amplifies and outputs the analog audio signal output to the headphone, and the lineout amplifier 14 amplifies the audio signal outputted to the external device through the lineout terminal. In the same manner, a video amplifier 20 amplifies a video signal output to an external display device through the audio/video plug. The reference numeral NC denotes a non-connected terminal.

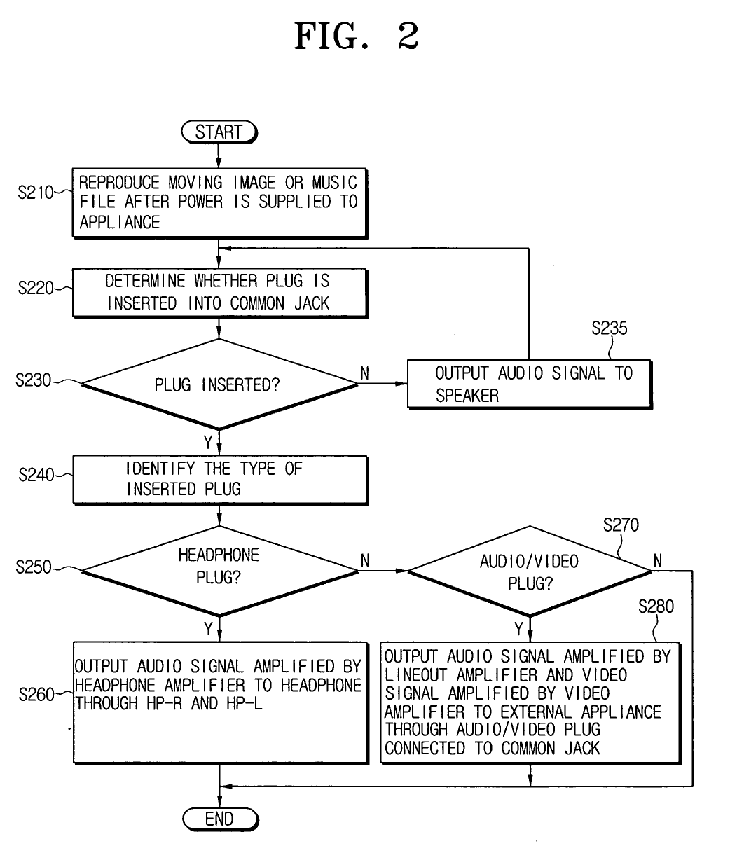

FIG. 2 is a flowchart illustrating a method for selectively outputting an audio/video signal and a headphone signal using an analog signal according to an embodiment of the present invention.

Referring to FIG. 2, after power is supplied to the portable composite appliance, the reproduction of a moving image or a music file is performed (step S210).

The microcomputer 40 determines whether a headphone plug or the audio/video plug is inserted into the common jack 50 (step S220).

In step 230, if no plug is inserted into the common jack 50 as a result of the determination at step S220, the microcomputer 40 performs a control operation so that the audio signal is output to a speaker (not shown) (step S235).

However, if the plug 60 is inserted into the common jack 50 as a result of the determination at step S220 (step S230), the microcomputer 40 identifies the type of plug 60 that is inserted in common jack 50 (step S240). That is, the microcomputer 40 determines whether the plug 60 inserted into the common jack 50 is the headphone plug or the audio/video plug.

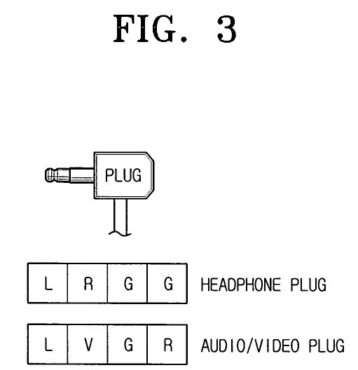

FIG. 3 is a view illustrating exemplary signals related to respective terminals of a headphone plug and an audio/video plug according to an embodiment of the present invention. Referring to FIG. 3, the way to judge the kind of the inserted plug 60 through the microcomputer 40 will be explained below in more detail.

Referring to FIG. 3, the order of terminals of the headphone plug (in the case of a stereo signal) is [Left-Right-GND-GND], and the order of terminals of the audio/video plug is [Left-Video-GND-Right].

The microcomputer 40 identifies the type of plug 60 that is inserted by detecting the signal level on the fourth terminal of the audio/video plug and the headphone plug. That is, the signal connected to the fourth terminal of the headphone plug is the ground (G) signal, and the signal connected to the fourth terminal of the audio/video plug is an audio right (R) signal. Accordingly, by detecting the level of the signal connected to the fourth terminal of the respective plugs, the type of the inserted plug can be identified.

At the first terminal, both the headphone plug and the audio/video plug are commonly connected to the audio left (L) signal, and thus the first terminal can be commonly used. However, because the gain of the headphone amplifier 12 is different from that of the line amplifier 14, the first terminal should be connected to either of the headphone left terminal HP-L and the audio left terminal A-L using the analog switches SW1 to SW3.

At the second terminal of the plug, the video signal is connected to the audio/video plug although the audio right (R) signal is connected to the headphone plug, and thus the switching operation using the analog switches is required. The ground (G) signal is connected to the third terminal of either plug, and thus the third terminal can also be commonly used.

At the fourth terminal of the plug, the audio right (R) signal is connected to the audio/video plug although the ground (G) signal is connected to the headphone plug, and thus a switching operation using the analog switches is required.

Meanwhile, if the plug 60 inserted into the common jack 50 is determined to be the headphone plug at step S240, the microcomputer 40 creates and outputs a switching control signal, preferably, of a high level to the switching unit 230.

If the high-level switching control signal is input to the switching unit 30, the switches will be preferably set as follows: the first switch SW1 of the first switching unit 32 is connected to the non-connected terminal NC; the second switch SW2 of the second switching unit 34 is connected to the headphone right terminal HP-R; and the third switch SW3 of the third switching unit 36 is connected to the headphone left terminal HP-L.

If the plug 60 inserted into the common jack 50 is determined to be the headphone plug through the above-described switch connection (step S250), the audio signal amplified by the headphone amplifier 12 is output to the headphone connected to the common jack 50 through the headphone right terminal HP-R and the headphone left terminal HP-L (step S260).

Meanwhile, if the plug 60 inserted into the common jack 50 is determined to be the audio/video plug at step S240, the microcomputer 40 creates and outputs the low-level switching control signal to the switching unit 30.

If the low-level switching control signal is input to the switching unit 30, the switches are set as follows: the first switch SW1 of the first switching unit 32 is connected to the audio right terminal A-R; the second switch SW2 of the second switching unit 34 is connected to the video terminal VIDEO; and the third switch SW3 of the third switching unit 36 is connected to the audio left terminal A-L.

If the plug 60 inserted into the common jack 50 is the audio/video plug through the above-described switch connection (step S270), the audio signal amplified by the lineout amplifier 14 and the video signal amplified by the video amplifier 20 are output to the external appliance such as the TV, the video player, etc., through the audio/video plug connected to the common jack 50 (step S280).

Consequently, by outputting the audio/video signal and the headphone signal through the common jack, the space occupied by the respective jacks in the portable composite appliance is reduced because a common jack can be used. Thereby allowing the multi-functional appliance to be miniaturized.

As described above, according to an embodiment of the present invention, by outputting the audio/video signal and the headphone signal through the common jack, the limited space in the multi-functional appliance can be more efficiently used, and the overall size of the multi-functional appliance can be minimized.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A method for selectively outputting an audio/video signal and a headphone signal, comprising the steps of:
reproducing a moving image or a music file;
determining whether a specified plug is inserted into a common jack;
if the specified plug is determined to be inserted, identifying the type of plug that is inserted; and
if the inserted plug is identified as a headphone plug, performing a switching operation so that an audio signal is output to a headphone connected to the common jack by generating and outputting a switching control signal having a first logic level.

2. The method as claimed in claim 1, further comprising the step of if the inserted plug is identified as an audio/video plug, performing a switching operation so that an audio/video signal is output to an external appliance through the audio/video plug connected to the common jack by generating and outputting a switching signal having a second logic level.

3. The method as claimed in claim 1, wherein the step of identifying the type of plug that is inserted comprises the step of detecting a level of a signal output from a specified terminal of the inserted plug.

4. The method as claimed in claim 1, further comprising the step of if the specified plug is not inserted into the common jack, outputting the audio signal to a speaker.

5. An apparatus for selectively outputting an audio/video signal and a headphone signal, comprising:
a common jack for outputting the audio/video signal to a headphone and an external display device;
a microcomputer for detecting whether a specified plug is inserted into the common jack, and if the specified plug is inserted as a result of the detection, identifying the type of plug that is inserted, the microcomputer generating and outputting a switching control signal of a first logic level if the specified plug is identified as a headphone plug, and generating and outputting a switching control signal of a second logic level if the specified plug is identified as an audio/video plug; and
a switching unit for performing a switchover to a specified headphone terminal according to the switching control signal of the first logic level and performing a switchover to a specified audio/video terminal according to the switching control signal of the second logic level.

6. The apparatus as claimed in claim 5, wherein if the switchover to the headphone terminal is performed, the audio signal is output to the headphone connected to the common jack.

7. The apparatus as claimed in claim 5, wherein if the switchover to the audio/video terminal is performed, the audio/video signal is output to an external appliance through the audio/video plug connected to the common jack.

8. The apparatus as claimed in claim 5, wherein the microcomputer identifies the type of plug that is inserted by detecting a level of a signal output from a specified terminal of the inserted plug.
